(19) United States
(12) Patent Application Publication
(10) Pub. No.: US 2025/0278680 A1
(43) Pub. Date: Sep. 4, 2025

(54) Planning of Loading and Route for Vehicles

(71) Applicant: ROBERT BOSCH GMBH, Stuttgart (DE)

(72) Inventors: Stefan Sellhusen, Sunnyvale, CA (US); Roland Werner, Sindelfingen (DE); Christoph Doerr, Koeln (DE); Falk Salzmann, Hausen an der Wurm (DE); Ulf Müller, Boblingen (DE); Thorsten Lajewski, Nurtingen (DE)

(21) Appl. No.: 18/547,721

(22) PCT Filed: Feb. 28, 2022
(86) PCT No.: PCT/EP2022/054983

§ 371 Date: Nov. 10, 2023

(30) Foreign Application Priority Data
Feb. 26, 2021 (DE) 10 2021 104 633.5

(51) Int. Cl. G06Q 10/047; G06Q 10/0832

(52) U.S. Cl. CPC G06Q 10/047; G06Q 10/0832

(57) ABSTRACT

A method is for planning a loading and a trip route of at least one vehicle for the transport of goods to a plurality of predefined unloading points. The method includes providing at least one candidate loading configuration of the vehicle, and providing at least one candidate route leading successively to all the predefined unloading points. The method also includes determining at least one predicted time schedule of the trip route to the unloading points based on the at least one candidate loading configuration, and the at least one candidate route in conjunction with at least map data, traffic data, and information about an availability of offloading places at the predefined unloading points. The method further includes evaluating the at least one candidate loading configuration and the at least one candidate route according to a predefined cost function by the use of the at least one predicted time schedule.

The present invention relates to planning the loading and trip route of vehicles for the transport of goods to predefined unloading points.

### PRIOR ART

In the transport of goods, in order to reduce the need for vehicles and energy to operate them, it is frequently the case that larger vehicles are used into which are loaded goods intended for many different unloading points. Usually, transloading systems are used at these unloading points, with the aid of which goods can be removed from the vehicle and, optionally, new goods can be loaded into the vehicle for further transport. One method of operating such a transloading system is known from DE 10 2015 210 994 A1.

Scheduling a trip route passing through multiple unloading points involves major uncertainties. In road traffic, there are always delays due to traffic jams or other disruptions in the traffic network. Unloading goods at an unloading point can also take longer than planned. These delays can accumulate over the course of a tour, and also build on one another such that the transport as a whole can only be completed at the cost of increased time and energy to operate the vehicle.

If the overall delay reaches a critical degree and a human driver-controlled vehicle is used, the delay can start all over again in discontinuous fashion due to regulations regarding breaks.

### DISCLOSURE OF THE INVENTION

In the context of the invention, a method for scheduling the loading and trip route of at least one vehicle for the transport of goods to a plurality of predefined unloading points has been developed.

To ultimately arrive at an optimal loading configuration and trip route for the vehicle, a candidate loading configuration of the vehicle is first provided. This generally refers to any information that characterizes the planned loading state of the vehicle as well as options for changing this loading state. Furthermore, at least one candidate route is provided which successively leads to all predefined unloading points.

Using the candidate loading configuration and the candidate route, in conjunction with at least map data, traffic data, and information about the availability of offloading places at the unloading points, at least one predicted time schedule of the trip to the unloading points is determined. The candidate loading function and the candidate route are evaluated using this predicted time schedule according to a predefined cost function.

Incorporated into this predefined cost function are goals that are tracked along with the optimization of the loading configuration and the trip route. For example, it may be that the cost function evaluation gets increasingly better
the shorter the time that the predicted time schedule takes overall, and/or
the shorter the time that at least one perishable good spends in the vehicle according to the predicted time schedule, and/or
the more goods to be loaded into the vehicle according to the candidate loading configuration, and/or
the closer the time when the vehicle is to arrive at at least one unloading point, according to the predicted time schedule, comes to an agreed-upon target time for this unloading point, and/or
the lower the expected energy consumption by the vehicle during the predicted time schedule.

These goals can certainly also be contradictory and/or specified by different entities. For example, the time schedule as a whole can be shortened within certain limits by increasing the travel speed and accelerating faster, but at the cost of driving up the energy consumption of the vehicle. Also, the goal of delivering a product to a “just-in-time customer” at exactly an agreed-upon target time can often only be achieved at the cost of losing the benefit of an unexpectedly good flow of traffic which would accrue to the overall time required for the tour, or having to “make good time” by increasing speed and acceleration after traffic backups occur.

It has been found that the value of the cost function depends on a complex interplay between the loading configuration on the one hand and the availability of offloading places at the unloading points on the other hand.

For example, the candidate loading configuration may include, in particular, a spatial arrangement of goods within the vehicle and/or accessibility options inside of the vehicle for the removal of goods. For example, at each unloading point, the interaction between the current spatial arrangement in the vehicle and the internal accessibility options in the vehicle may decide the amount of time and/or the additional technical tools required to unload from the vehicle a specific good determined for this unloading point.

For example, truck structures in the form of seaworthy containers are only accessible through a door in an end wall, such that access to goods loaded into such a container may essentially only be possible according to a LIFO principle (last in, first out). Thus, access to goods other than the last loaded goods may require that other goods be unloaded first and later reloaded. This leads to excess time and use of corresponding tools, for example, material-handling equipment.

On the other hand, tarped truck structures can also be opened to the side, for example, or even upward in order to remove goods. But then again, many of these removal options can only be used if certain tools are available. For example, a loading ramp at the unloading point may allow goods to be easily rolled out of the truck from the back. On the other hand, in order to remove goods laterally, a forklift may be required, and to remove goods upwards completely free of restrictions, a crane is required.

Thus, the availability of offloading places is not necessarily satisfied simply by the presence of a space where the vehicle can be parked for unloading purposes. Rather, the availability of offloading places can, for example, also in particular require
the availability of at least one structural facility for the same-height removal of goods from the vehicle, and/or
the availability of at least one tool for unloading goods from the vehicle at the respective offloading place.

Also, the availability of tools can in turn be affected by the loading configuration. For example, the loading configuration may involve carrying along at least one tool for unloading goods from the vehicle. Such a tool can, in particular, be a lifting cart or other floor conveyor, for example.

Furthermore, optimizing the candidate loading configuration may also include, for example, replacing the vehicle to be used with a vehicle that has enhanced internal accessibility options for the removal of goods. For example, a container that is only accessible through a door at the back can be replaced by a trailer with a tarp that is also accessible from the side and/or from above for the removal of goods.

As part of the method, the candidate loading configuration and the candidate route are optimized with the objective that the re-evaluation, using the cost function, after the predicted time schedule has been updated leads to a better evaluation. As a result of this optimization, there is a final loading configuration according to which the vehicle may be loaded, and a final route that the vehicle may travel in the loaded state.

In this context, the term “optimize” is not to be construed as limiting in that, starting from a first candidate route and candidate loading configuration, the value of the cost function resulting therefrom must necessarily be used to determine the next candidate route and candidate loading configuration to be tested, as is done for example using a gradient descent method. Rather, it is also possible, for example, to create a grid of candidate routes and candidate loading configurations in a multi-dimensional space and systematically search through it. The candidate route and candidate loading configuration in the grid yielding the best value for the cost function may then be selected as the final route and the final loading configuration. In this way, for example, an optimum can be reliably found even if the cost function does not always depend on parameters that characterize the candidate route or the candidate loading function.

This particular searching in a grid is not practical for human logistics experts. The human expert is usually guided by certain empirical principles and heuristics, which already drastically limit the range of possibilities to be examined in detail. At least one local optimum can be found relatively quickly this way. However, it is quite possible that in areas of the search space omitted by the empirical principles and heuristics, there are still candidate routes and candidate loading configurations that result in an even better cost function value. It is precisely these candidate routes and candidate loading configurations that can be found in the grid by the search.

In particular, changes to the candidate loading configuration can also be found which, for example, are not intuitive or even counter-intuitive when starting from conventional empirical principles and heuristics.

For example, optimizing the candidate loading function may include, in particular, removing goods from the candidate loading configuration such that there is empty space inside the vehicle according to the changed candidate loading configuration. This contradicts conventional strategies in which maximum utilization of the available loading space is an important element. However, the empty space can result in the goods remaining in the vehicle interior being more unrestrictedly accessible, i.e., they can be removed without having to first remove other goods and subsequently load them again. For example, in a truck trailer or container that is only accessible from the rear via a door in the back and that is usually completely filled with cartons or pallets, a passageway can be left open which runs all the way through the container from the rear to the front. Then, cargo located in the trailer or container all the way up front, which would therefore normally be the last to be accessible, is freely accessible from the beginning.

This in turn allows the trip route to be rescheduled spontaneously to respond to unforeseen events. For example, if a highway leading to the next designated unloading point is backed up for a short time, or even fully blocked off, other unloading points that can be reached without using this currently unavailable highway can be driven to first. Time is thus used more sensibly than just waiting for traffic to continue along the originally planned route. However, if, for example, a container which is still full were to require complete unloading at such an alternative unloading point in order to get to the 10% of the contents of this container located all the way in the front of the container, the resulting disadvantages would again nullify the time advantage in most cases.

Such flexibility for unloading can be provided if, for example, the available data show that there is a degree of probability for concern that departure on a planned route will be affected by a larger disruption. For example, a passage of time can allow a determination to be made from traffic data as to which road sections of the traffic network are particularly susceptible to congestion. Furthermore, for example, from a prior history of actual patterns of trips actually taken, unloading points can also be identified where there are repeatedly delays, for example because of personnel shortages or poor organization. Such a delay can, for example, result in having to use, later in the course of the planned route and precisely during rush hour, a highway which is prone to traffic jams, thereby further compounding the delay.

In a further advantageous embodiment, to be able to take unforeseen events into account better, at least one further predicted time schedule is determined under the assumption that the trip duration to at least one unloading point and/or the wait time at at least one unloading point is shortened or extended in comparison to the original predicted time schedule. Then, also a cost function value that the cost function provides when using this further predicted time schedule can be included in the evaluation of the candidate loading configuration and the candidate route.

For example, a combination of a candidate route and a candidate loading configuration may initially promise a very good cost function value because driving from one unloading point to the next and unloading goods at each location is very efficient. However, it may now be the case, for example, that the full tour is then practically “tight as a drum” and even a slight delay at one point will trigger a chain reaction which culminates in a very significant delay. The situation is a bit like planning a train trip in which a connection involving two train changes and a changing time of 5 minutes each promises the shortest total travel time nominally. The probability is relatively low that both changes are made and the promised short overall travel time is actually possible. Selecting a connection free of changes and “sacrificing” 10 minutes for it can then make more sense than being nominally faster but actually losing an hour waiting for the next connection and also forfeiting the reserved seat.

Thus, particularly advantageous cost function values determined by using different predicted time schedules are each weighted with the probability that the actual time schedule of the trip to the unloading points will correspond to the predicted time schedule, respectively. The optimization then preferably converges to candidate routes and candidate loading configurations that promise a good cost function value relatively independently of external disruptions.

In a further advantageous configuration, the optimization of the candidate route is repeated starting from a fixed state of the loading configuration. In this way, especially after the start of the trip, the planning can, for example, in particular be updated starting from the loading configuration currently in place in the vehicle. For example, a route and loading configuration for the day may initially be scheduled in the morning, and this plan may be updated at noon to better respond to the traffic levels which have increased in the meantime and to delays that have already occurred.

As discussed above, the method ultimately aims to improve the efficiency of the physical transport of goods beginning from a start point to a plurality of unloading points.

Thus, the invention also provides a method of operating a vehicle. This method begins with planning the loading and trip route of the vehicle according to the method described above. The vehicle is loaded according to the optimized loading configuration determined herein. Then, the vehicle is caused to drive the optimized route to the unloading points.

In an advantageous embodiment, the optimization of the candidate route is repeated during the trip starting from the current actual loading configuration of the vehicle. The vehicle is then caused to drive the new optimized route so obtained. As explained above, this can be used to respond to interim changes in the situation, such as increased traffic, delays that have already occurred, or an offloading place which is not available on short notice.

In a further advantageous embodiment, the actual time schedule of the trip to the unloading points is recorded and used to determine future predicted time schedules. This increases the likelihood that this time schedule can actually be achieved in a future trip plan, and that the advantageous effects of a route and loading configurations planned in connection with this time schedule can therefore be realized. In particular, routes and loading configurations that are too “tight as a drum” and only promise a theoretical advantage that cannot be achieved in practice can be screened out.

The method may in particular be computer-implemented as a whole or in part. The invention therefore also relates to a computer program including machine-readable instructions which, when executed on one or more computers, cause the computer or computers to perform one of the methods described. In this sense, control units for vehicles and embedded systems for technical devices that are likewise capable of executing machine-readable instructions are also to be regarded as computers.

Likewise, the invention also relates to a machine-readable data storage medium and/or to a download product including the computer program. A download product is a digital product that can be transmitted via a data network, i.e., can be downloaded by a user of the data network, and may, for example, be offered for sale in an online shop for immediate download.

Furthermore, a computer may be equipped with the computer program, with the machine-readable storage medium, or with the download product.

Further measures improving the invention are described in more detail below on the basis of the figures, together with the description of the preferred exemplary embodiments of the invention.

### EXEMPLARY EMBODIMENTS

Shown are:

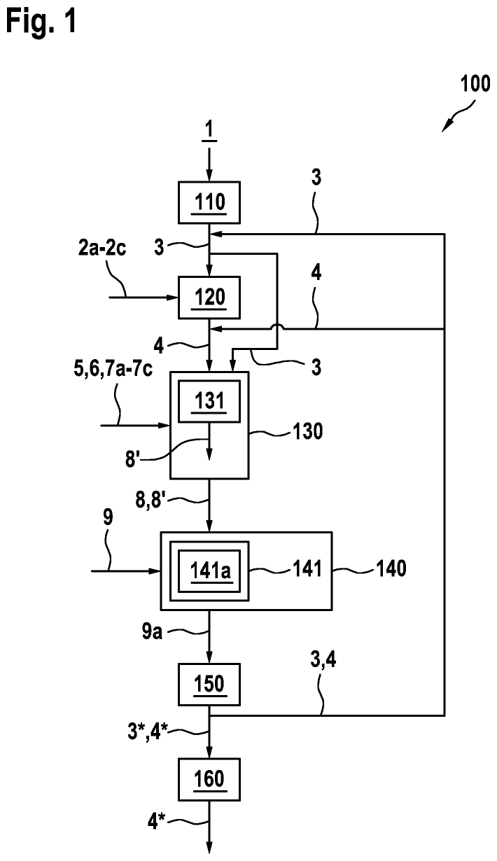

FIG. 1 An exemplary embodiment of the method 100 for planning the loading 3 and trip route 4 of a vehicle 1;

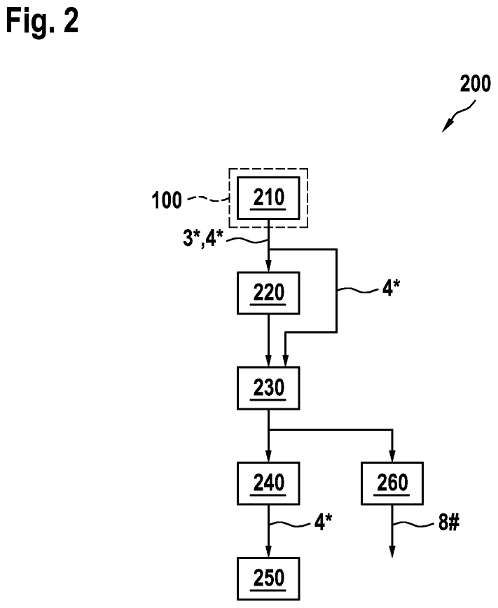

FIG. 2 An exemplary embodiment of the method 200 for operating a vehicle 1.

FIG. 1 is a schematic flow diagram of an exemplary embodiment of the method 100 for planning the loading 3 and trip route 4 of a vehicle 1.

In step 110, at least one candidate loading configuration 3 of the vehicle 1 is provided. In step 120, at least one candidate route 4 is provided that successively leads to all predefined unloading points 2a-2c.

In step 130, using the candidate loading configuration 3 and the candidate route 4 in conjunction with at least map data 5, traffic data 6, as well as information regarding the availability of offloading places 7a-7c at unloading points 2a-2c, at least one predicted time schedule 8 of the trip to unloading points 2a-2c is determined. Here, in particular for example according to block 131, at least one further predicted time schedule 8′ may be determined under the assumption that the trip duration to at least one unloading point 2a-2c and/or the wait time at at least one unloading point 2a-2c is shortened or extended in comparison to the original predicted time schedule 8.

In step 140, using the predicted time schedule 8, the candidate loading configuration 3 and the candidate route 4 are evaluated according to a predefined cost function 9. In this case, in particular for example according to block 141, a value of the cost function 9 which the cost function 9 provides when using this further predicted time schedule 8′ can also be supplied. Values of the cost function 9 determined using different predicted time schedules 8, 8′ may each be weighted, in particular for example according to block 141a, with the probability that the actual time schedule of the trip to the unloading points 2a-2c will correspond to the particular predicted time schedule 8, 8′, respectively.

In step 150, the candidate loading configuration 3 and the candidate route 4 are optimized with the goal that re-evaluation by the cost function 9 after updating the predicted time schedule 8 results in a better evaluation 9a. The optimized loading configuration and route are denoted by reference numerals 3* and 4*, respectively.

In step 160, the optimization of the candidate route 4 may be repeated starting from a fixed state of the loading configuration 3 (for example the previously-determined optimized loading configuration 3*). A new optimized route 4* is then created.

FIG. 2 shows a schematic flow chart of an exemplary embodiment of the method 200 for operating a vehicle 1.

In step 210, the loading 3 and trip route 4 of the vehicle 1 are planned using the method 100 described above. The vehicle 1 is loaded in step 220 according to the optimized loading configuration 3*. In step 230, the vehicle 1 is caused to drive the optimized route 4* to the unloading points 2a-2c.

In step 240, the optimization 150 of the candidate route 4 may be repeated during the trip starting from the current actual loading configuration 3 of the vehicle 1. In step 250, the vehicle 1 can then be caused to drive the new optimized route 4* obtained thereby.

In step 260, the actual time schedule 8# of the trip to the unloading points 2a-2c may be recorded and used to determine future predicted time schedules.

1. A method for planning a loading and a trip route of at least one vehicle for transporting goods to a plurality of predefined unloading points, the method comprising:
providing at least one candidate loading configuration of the vehicle;
providing at least one candidate route leading successively to all the predefined unloading points;
determining at least one predicted time schedule of the trip route to the unloading points using the at least one candidate loading configuration and the at least one candidate route in conjunction with at least map data, traffic data, and information about an availability of offloading places at the predefined unloading points;
evaluating, using the at least one said predicted time schedule, the at least one candidate loading configuration and the at least one candidate route according to a predefined cost function; and
optimizing the at least one candidate loading configuration and the at least one candidate route with an objective that a reevaluation using the predefined cost function after the at least one predicted time schedule has been updated leads to a better evaluation.

2. The method according to claim 1, wherein the evaluation according to the predefined cost function gets increasingly better (i) the shorter the time that an overall predicted time schedule takes, (ii) the shorter the time that at least one perishable good spends in the vehicle according to the predicted time schedule, (iii) the more goods to be loaded into the vehicle according to the at least one candidate loading configuration, (iv) the closer the time when the vehicle is to arrive at at least one unloading point according to the at least one predicted time schedule comes to an agreed-upon target time for this unloading point, and/or (v) the lower an expected energy consumption by the vehicle during the at least one predicted time schedule.

3. The method according to claim 1, wherein the at least one candidate loading configuration includes (i) a spatial arrangement of goods within the vehicle, (ii) accessibility options inside the vehicle for removing goods, and/or (iii) carrying along at least one tool for unloading goods from the vehicle.

4. The method according to claim 1, wherein the availability of offloading places includes (i) an availability of at least one structural facility for the same-height removal of goods from the vehicle, and/or (ii) an availability of at least one tool for unloading goods from the vehicle at the respective unloading point.

5. The method according to claim 1, further comprising:
determining at least one further predicted time schedule under an assumption that a trip duration to at least one unloading point of the plurality of predefined unloading points and/or a wait time at at least one unloading point of the plurality of predefined unloading points is shortened or extended in comparison to an original predicted time schedule; and
wherein a cost function value that the cost function provides when using the further predicted time schedule is included in the evaluation of the at least one candidate loading configuration and the at least one candidate route by the cost function.

6. The method according to claim 5, wherein values of the cost function determined using different predicted time schedules are each weighted with a probability that an actual time schedule of the trip route to the unloading points will correspond to the at least one predicted time schedule, respectively.

7. The method according to claim 1, wherein optimizing the candidate loading configuration includes (i) removing goods from the at least one candidate loading configuration such that, according to a changed candidate loading configuration, there is an empty space inside the vehicle; (ii) in the at least one candidate loading configuration, replacing goods with a tool for unloading goods from the vehicle; and/or (iii) replacing the vehicle to be used with a vehicle that has enhanced internal accessibility options for removing goods.

8. The method according to claim 1, wherein optimization of the at least one candidate route is repeated starting from a fixed state of the loading configuration.

9. A method for operating a vehicle for delivering goods to a plurality of predefined unloading points, comprising:
planning the loading and the trip route of the vehicle using the method according to claim 1;
loading the vehicle according to the at least one optimized loading configuration; and
causing the vehicle to drive the optimized route to the unloading points.

10. The method according to claim 9, wherein:
the optimization of the candidate route is repeated during the trip starting from a current actual loading configuration of the vehicle, and
the vehicle is caused to drive the new optimized route obtained thereby.

11. The method according to claim 9, wherein an actual time schedule of the trip route to the unloading points is recorded and used to determine future predicted time schedules.

12. The method according to claim 1, wherein a computer program, including machine-readable instructions that, when executed on one or more computers, prompt the computer or computers to carry out the method.

13. The method according to claim 12, wherein a nontransitory machine-readable storage medium and/or download product includes the computer program.

14. The method according to claim 13, wherein one or more computers have the computer program and/or the nontransitory machine-readable storage medium and/or download product.
